(19) United States
(12) Patent Application Publication
(10) Pub. No.: US 2004/0090775 A1
(43) Pub. Date: May 13, 2004

(54) Multi-function flashlight

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/289,276

(22) Filed: Nov. 7, 2002

(51) Int. Cl. F21L 4/02

(52) U.S. Cl. 362/184; 362/205

(57) ABSTRACT

A flashlight includes a body having batteries received therein and a first head and a second head are respectively connected to two ends of the body. Each head has a bulb and reflection hood assembly enclosed therein and electrically connected to the power supply of the batteries. A tube extends from an outer periphery of the body and a third head is connected to the tube. A bulb and reflection hood assembly is connected to the tube and enclosed by the third head. A switch is connected to the body and electrically controls the connection of the three bulb and reflection hood assemblies.

### FIELD OF THE INVENTION

The present invention relates to a multi-function flashlight which has three heads, two of which are located at two ends of the tubular body and the other one extends from an outer periphery of the body.

### BACKGROUND OF THE INVENTION

A conventional flashlight 10 is shown in FIG. 1 and generally includes a head 12 on a first end of the tubular body 11 and a second end of the body 11 is a closed end. A bulb with a reflection hood are located in the head 12 and batteries 14 are received in the body 11. A rotatable adjusting collar 15 is connected to the head 12 and controls the movement of the position of the bulb. The head 12 is fixedly located at the axial direction of the body 11 and cannot be adjusted relative to the body 11 so that the user has to move the body 11 if he or she wants to spot at an object located at his or her side or on the ground just in front of him or her. When the user walks on a dark path, in order to get more information about the site around the user, the user must frequently move the flashlight and this is not convenient.

The present invention intends to provide a flashlight that has three heads and each includes a bulb so that the flashlight provides a large area that is illuminated.

### SUMMARY OF THE INVENTION

In accordance with one aspect of the present invention, there is provided a flashlight which comprises a body having batteries received therein and an electric positive pad and an electric negative pad are respectively located at two ends of a space in the body. The batteries are electrically connected to the electric positive pad and the electric negative pad. A first head and a second head are respectively connected to two ends of the body, and two bulb and reflection hood assemblies are respectively connected to the two ends of the body and enclosed by the first head and the second head.

A tube extends from an outer periphery of the body and a third head is connected to the tube. A bulb and reflection hood assembly is connected to the tube and enclosed by the third head. The three bulb and reflection hood assemblies are connected to the electric positive pad and the electric negative pad. A switch is connected to the body and electrically controls the connection of the three bulb and reflection hood assemblies and the electric positive pad and the electric negative pad.

The primary object of the present invention is to provide a flashlight that has three bulbs so as to simultaneously illuminate three directions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional flashlight;

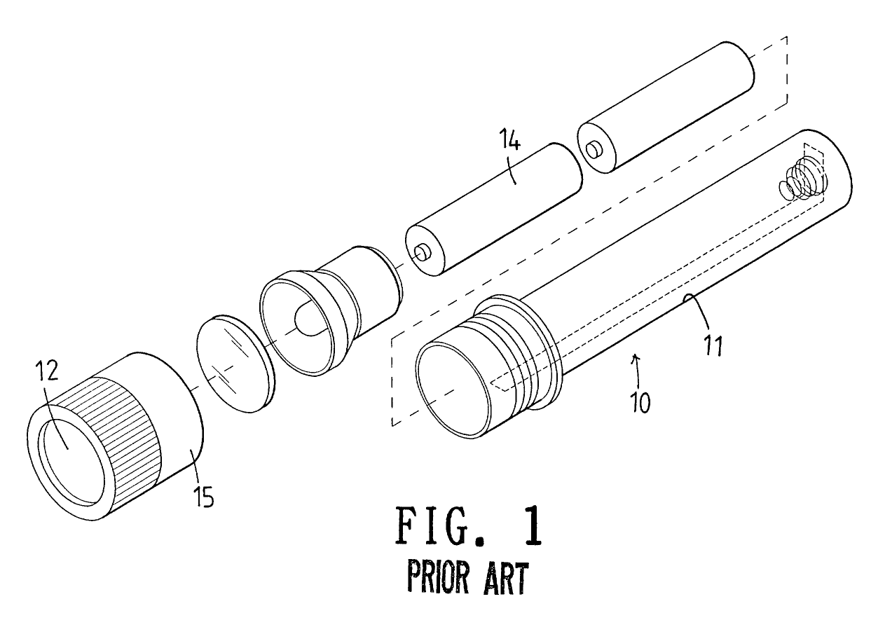

FIG. 2 is an exploded view to show the flashlight of the present invention;

FIG. 3 is a cross sectional view to show the flashlight of the present invention;

FIGS. 4 and 5 show the flashlight of the present invention in different angles;

FIG. 6 is an exploded view to show another embodiment of the flashlight of the present invention, and

FIG. 7 shows a cross sectional view of the flashlight as shown in FIG. 6.

### DETAILED DESCRIPTION OF THE PREFERRED EMBODIMENT

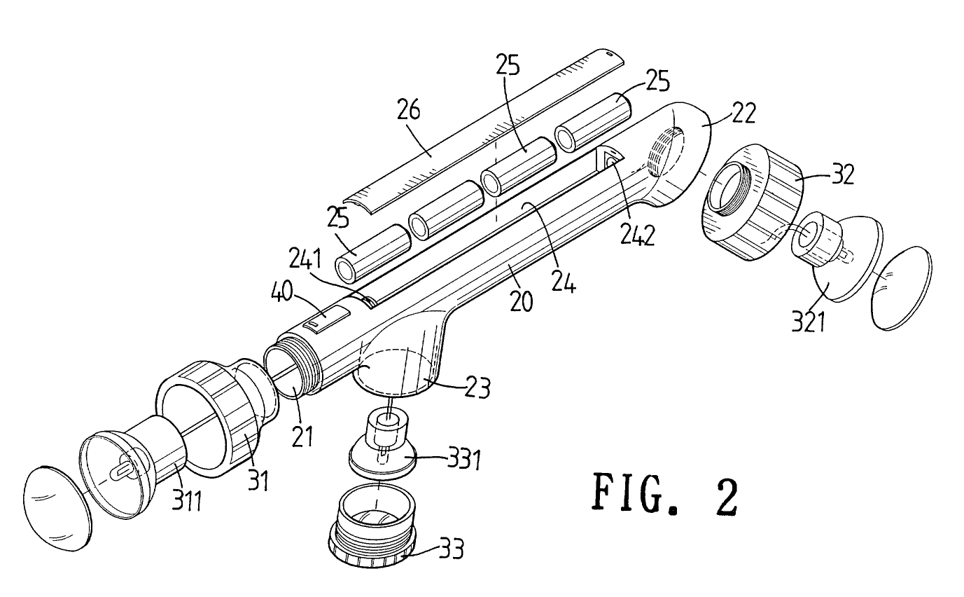

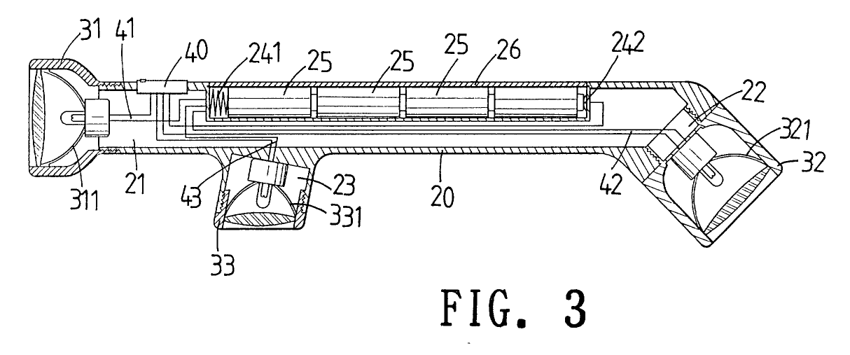

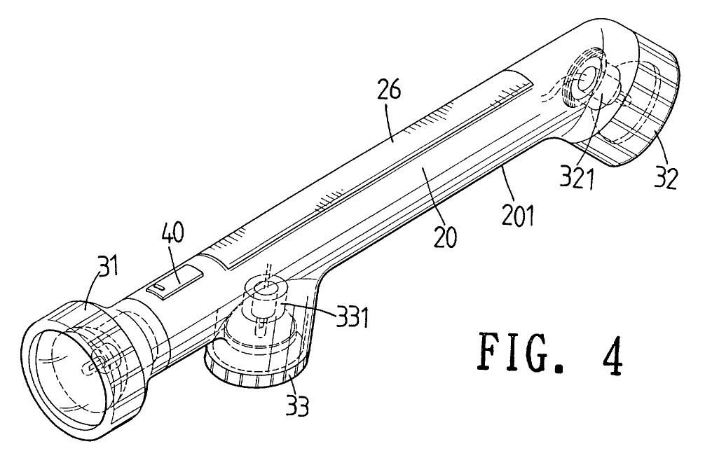

Referring to FIGS. 2 to 5, the flashlight of the present invention comprises a body 20 having batteries 25 received in a space in the body 20 and a cap 26 is connected to the body 20 to close the space such that the batteries 25 are retained in the space. An electric positive pad 241 and an electric negative pad 242 are respectively located at two ends of the space in the body 20. The batteries 25 are electrically connected to the electric positive pad 241 and the electric negative pad 242. A first head 31 and a second head 32 are respectively connected to two ends 21, 22 of the body 20. Two bulb and reflection hood assemblies 311, 321 are respectively connected to the two ends 21, 22 of the body 20 and enclosed by the first head 31 and the second head 32.

A tube 23 extends from an outer periphery of the body 20 and a third head 33 is connected to the tube 23. A bulb and reflection hood assembly 331 is connected to the tube 23 and enclosed by the third head 33. The three bulb and reflection hood assemblies 311, 321, and 331 are connected to the electric positive pad 241 and the electric negative pad 242 by three individual circuits 41, 42, 43.

A switch 40 is connected to the body 20 and electrically controls the connection of the three bulb and reflection hood assemblies 311, 321, and 331 and the electric positive pad 241 and the electric negative pad 242. In other words, the three bulb and reflection assemblies 311, 321, 331 can be activated simultaneously or individually by operating the switch 40. Therefore, the flashlight provides three directions of illumination without moving the flashlight frequently.

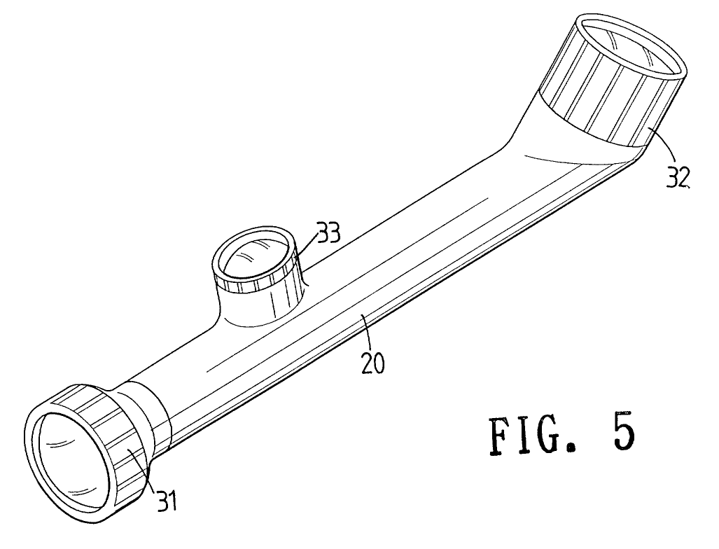

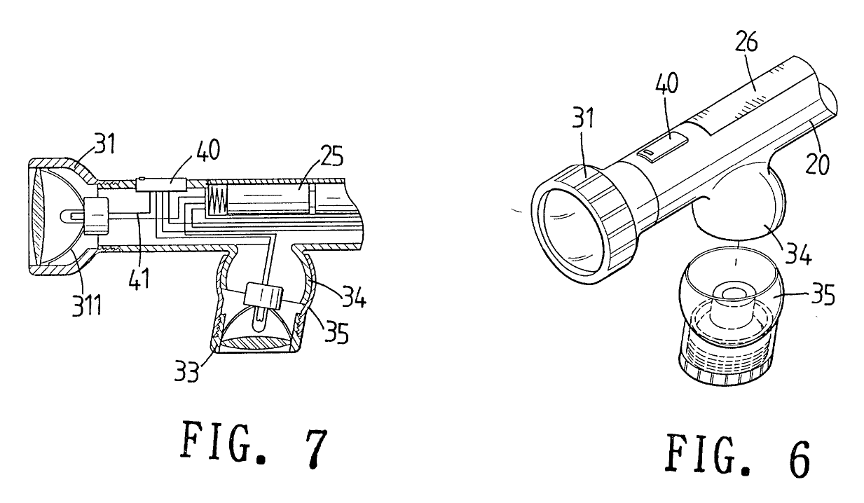

Referring to FIGS. 6 and 7, the tube may have a bowl-shaped outer periphery and the third head 35 has a complementary shape connection portion which is rotatably mounted to the bowl-shaped outer periphery 34. By the arrangement, the direction that the bulb and reflection assembly in the third head 35 illuminates can be adjusted according to the user's needs.

While we have shown and described the embodiment in accordance with the present invention, it should be clear to those skilled in the art that further embodiments may be made without departing from the scope of the present invention.

What is claimed is:

1. A flashlight comprising:
a body having batteries received in a space in the body, an electric positive pad and an electric negative pad respectively located at two ends of the space in the body, the batteries electrically connected to the electric positive pad and the electric negative pad, a first head and a second head respectively connected to two ends of the body, two bulb and reflection hood assemblies respectively connected to the two ends of the body and enclosed by the first head and the second head;
a tube extending from an outer periphery of the body and a third head connected to the tube, a bulb and reflection hood assembly connected to the tube and enclosed by the third head, the three bulb and reflection hood assemblies connected to the electric positive pad and the electric negative pad, and
a switch connected to the body and electrically controlling the connection of the three bulb and reflection hood assemblies and the electric positive pad and the electric negative pad.

2. The flashlight as claimed in claim 1, wherein the three bulb and reflection hood assemblies are respectively connected to the electric positive pad and the electric negative pad by three individual circuits.

3. The flashlight as claimed in claim 1, wherein the tube has a bowl-shaped outer periphery and the third head are rotatably mounted to the bowl-shaped outer periphery.
